(19) United States
(12) Patent Application Publication
(10) Pub. No.: US 2013/0169733 A1
(43) Pub. Date: Jul. 4, 2013

(54) DEVICE AND METHOD FOR PROVIDING API FOR SHARING CONTENTS

(71) Applicants: Uk JANG, Seoul (KR); Hyun Jin LEE, Daejeon (KR); Sang Kwon KIM, Daejeon (KR); Cho Rong YU, Daejeon (KR); Dong Hun LEE, Daejeon (KR); Kee Seong CHO, Daejeon (KR)

(72) Inventors: Uk JANG, Seoul (KR); Hyun Jin LEE, Daejeon (KR); Sang Kwon KIM, Daejeon (KR); Cho Rong YU, Daejeon (KR); Dong Hun LEE, Daejeon (KR); Kee Seong CHO, Daejeon (KR)

(73) Assignee: Electronics and Telecommunications Research Institute, Daejeon (KR)

(21) Appl. No.: 13/571,962

(22) Filed: Aug. 10, 2012

(30) Foreign Application Priority Data
Jan. 3, 2012 (KR) 10-2012-0000643

(51) Int. Cl. H04N 7/14

(52) U.S. Cl. 348/14.01; 348/E07.077

(57) ABSTRACT

Disclosed are an apparatus and a method for providing an API for sharing contents which provides the API including a function capable of sharing contents during a video call or video conference in a platform including an open web service gateway by using functions provided from the open web service gateway. The apparatus for providing an API for sharing contents during video communication in a platform including an open web service gateway includes: a video communication control unit configured to acquire connection state information of terminals receiving a video communication request; and a contents sharing control unit configured to receive the connection state information of the terminals from the video communication control unit and process a contents sharing request.

### CROSS-REFERENCE TO RELATED APPLICATIONS

This application claims priority to and the benefit of Korean Patent Application No. 10-2012-0000643 filed in the Korean Intellectual Property Office on Jan. 3, 2012, the entire contents of which are incorporated herein by reference.

### TECHNICAL FIELD

The present invention relates to an apparatus and a method for providing an API for sharing contents. More particularly, the present invention relates to an apparatus and a method for providing an API for sharing contents during video communication in a platform including an open web service gateway.

### BACKGROUND ART

A platform including an open web service gateway enables various services independently from lower communication network architecture to be developed by separating a service layer of a communication network from a control and transport layer of the communication network and introducing a standardized interface into the separated layers.

The platform including the open web service gateway provides a standardized open application programming interface (API) in the communication network architecture. That is, the platform including the open web service gateway is opened so that Internet based application programs may use a function of the communication network and enables the creation of new additional services in which an information technology and a communication technology are combined with each other.

Parlay or OSA, which are the open API, is an open service interface capable of developing communication services independently from a communication network infrastructure. The API has a language or message format that is used for communication between an operating system and application programs. The API has a language or message format used when the application programs communicate with system programs such as the operating system, a database management system, and the like. The API is implemented as calling a function of providing a connection with a specific subroutine so as to be executed within programs. A single API may have several program modules or routines that are already present or are to be connected so as to perform operations requested by the calling of the function.

A web service concept has been introduced as a methodology of reducing costs integrating software and developing new applications in which developed functions are combined with each other in different domains. With the introduction of the web service concept, a parlay API or a parlay-X API extends to an open service interface such as a parlay web service API, a parlay-X web service API, and the like, so as to develop new applications by using the functions of the communication network in web service based applications.

The parlay web service API is an interface defined by an extensible markup language (XML) based web service description language (WSDL) that forms the parlay APIs into a web service type for developers intending to develop communication services based on the web service.

The parlay-X web service API is an open service interface that is being standardized as the XML based WSDL by more abstracting and simplifying the parlay APIs defined as a COBRA based interface definition language (IDL) for IT based developers that are not accustomed to the functions of the communication network.

However, when intending to develop services for sharing contents during video communication such as a video call or video conference by using the functions provided in the platform including the open web service gateway in the related art, there is a need to self-combine a large number of basic functions and then, implement service execution logics in an application server in the view of the service developer.

### SUMMARY OF THE INVENTION

The present invention has been made in an effort to provide an apparatus and a method for providing an API for sharing contents, which provide a function of sharing contents during a video conference or video call in a platform including an open web service gateway.

An exemplary embodiment of the present invention provides an apparatus for providing an API for sharing contents during video communication in a platform including an open web service gateway, the apparatus including: a video communication control unit configured to acquire connection state information of terminals receiving a video communication request; and a contents sharing control unit configured to receive the connection state information of the terminals from the video communication control unit and process a contents sharing request.

The video communication control unit may acquire the connection state information of the terminals based on whether the terminals respond to the video call or video conference request.

The connection state information of the terminals according to the response of the terminals may be acquired as the state information that the terminals are disconnected, when the terminals reject the request, and as the state information that the terminals are connected, when the terminals approve the request.

The contents sharing control unit may include: a connection state information acquisition unit configured to acquire the connection state information of the terminals from the video communication control unit; and when information acquired from the connection state information acquisition unit is the state information that the terminals are connected, a contents sharing unit configured to share the sharing-requested contents in the terminals with the state information that the terminals are connected.

The connection state information acquisition unit may acquire the connection state information of the terminals by using a notification mechanism provided from the open web service gateway.

The notification mechanism may be a mechanism that requests the connection state information of the terminals to the video communication control unit as a start notification function provided from the open web service gateway when the connection state information acquisition unit receives the contents sharing request, and delivers the connection state information of the terminals to the connection state information acquisition unit as a notify function provided from the open web service gateway when the video communication control unit receives the request of the connection state information as the start notification function.

The contents sharing unit may include: when a format of the sharing-requested contents is a web format, a message sharing unit configured to share the contents of the sharing-requested web format in the terminals with the state information that the terminals are connected; and when the format of the sharing-requested contents is a video on demand (VOD) format, a VOD sharing unit configured to share the contents of the sharing-requested VOD format in the terminals with the state information that the terminals are connected.

The message sharing unit may share the contents of the web format in the terminals with the state information that the terminals are connected, by using a message delivery function provided from the open web service gateway.

The VOD sharing unit may share the contents of the VOD format in the terminals with the state information that the terminals are connected, by using a VOD playback function provided from the open web service gateway.

The apparatus for providing an API for sharing contents may further include: a contents division unit configured to divide whether the sharing-requested contents are the contents of the web format or the contents of the VOD format.

The contents sharing control unit may further include an additional contents sharing unit configured to receive the notification of the connection presence of additional terminals from the connection state information acquisition unit when the additional terminals are connected with the video communication after the sharing of the sharing-requested contents in the connected terminals starts, and share at least one of the sharing or shared contents in the additionally connected terminals.

Another exemplary embodiment of the present invention provides a method for providing an API for sharing contents during video communication in a platform including an open web service gateway, the method including: a video communication controlling step of requesting a video call or video conference to a terminal and acquiring connection state information of the terminals; and a contents sharing controlling step of receiving the connection state information of the terminals from a video communication control unit and processing a contents sharing request.

The contents sharing controlling step may include: a connection state information acquiring step of acquiring the connection state information of the terminals from the video communication control unit; and when information acquired in the connection state information acquiring step is the state information that the terminals are connected, a contents sharing step of sharing the sharing-requested contents in the terminals with the state information that the terminals are connected.

In the connection state information acquiring step, the connection state information of the terminals may be acquired by using a notification mechanism provided from the open web service gateway.

The notification mechanism may be a mechanism that requests the connection state information of the terminals in the video communication controlling step as a start notification function provided from the open web service gateway in the connection state information acquiring step, and delivers the connection state information of the terminals in the connection state information acquiring step as a notify function provided from the open web service gateway in the video communication controlling step.

The contents sharing step may include: when a format of the sharing-requested contents is a web format, a message sharing step of sharing the contents of the sharing-requested web format in the connected terminals; and when the format of the sharing-requested contents is a video on demand (VOD) format, a VOD sharing step of sharing the contents of the sharing-requested VOD format in the terminals with the state information that the terminals are connected.

The message sharing step may share the contents of the web format in the terminals with the state information that the terminals are connected, by using a message delivery function provided from the open web service gateway.

The VOD sharing step may share the contents of the VOD format in the connected terminals by using a VOD playback function provided from the open web service gateway.

The method may further include: a contents division step of dividing whether the sharing-requested contents are the contents of the web format or the contents of the VOD format.

The contents sharing control step may further include: an additional contents sharing step of receiving the notification of the connection presence of additional terminals from the connection state information acquiring step when the additional terminals are connected with the video communication after the sharing of the sharing-requested contents in the connected terminals starts and sharing at least any one of the sharing or shared contents in the additionally connected terminals.

The apparatus and method for providing an API for sharing contents according to the exemplary embodiments of the present invention need not implement the combined logics in the application server after combining a large number of functions for sharing contents during the video communication by providing the open API for sharing contents during the video communication in the platform including the open web service gateway, thereby making it possible to save the time and costs of the service developers and the users and promote the convenience.

The apparatus and method for providing an API for sharing contents according to the exemplary embodiments of the present invention can conveniently provide contents even to additional participants during the video communication.

The foregoing summary is illustrative only and is not intended to be in any way limiting. In addition to the illustrative aspects, embodiments, and features described above, further aspects, embodiments, and features will become apparent by reference to the drawings and the following detailed description.

### BRIEF DESCRIPTION OF THE DRAWINGS

FIG. 1 is a block diagram of an apparatus for providing an API for sharing contents according to an exemplary embodiment of the present invention.

FIG. 2 is a block diagram for describing an exemplary embodiment of a video communication control unit in the apparatus for providing an API for sharing contents according to the exemplary embodiment of the present invention.

FIG. 3 is a block diagram for describing an exemplary embodiment of a contents sharing control unit in the apparatus for providing an API for sharing contents according to the exemplary embodiment of the present invention.

FIG. 4 is a block diagram for describing a contents sharing unit of the contents sharing control unit in the apparatus for providing an API for sharing contents according to the exemplary embodiment of the present invention.

FIG. 5 is a block diagram for describing an exemplary embodiment of a system to which the apparatus for providing an API for sharing contents according to the exemplary embodiment of the present invention is applied.

FIG. 6 is a flow chart of a method for providing an API for sharing contents according to an exemplary embodiment of the present invention.

FIG. 7 is a flow chart for describing a process to which the method for providing an API for sharing contents according to the exemplary embodiment of the present invention is applied.

It should be understood that the appended drawings are not necessarily to scale, presenting a somewhat simplified representation of various features illustrative of the basic principles of the invention. The specific design features of the present invention as disclosed herein, including, for example, specific dimensions, orientations, locations, and shapes will be determined in part by the particular intended application and use environment.

In the figures, reference numbers refer to the same or equivalent parts of the present invention throughout the several figures of the drawing.

### DETAILED DESCRIPTION

Hereinafter, exemplary embodiments of the present invention will be described in detail with reference to the accompanying drawings. First of all, we should note that in giving reference numerals to elements of each drawing, like reference numerals refer to like elements even though like elements are shown in different drawings. In describing the present invention, well-known functions or constructions will not be described in detail since they may unnecessarily obscure the understanding of the present invention. It should be understood that although exemplary embodiment of the present invention are described hereafter, the spirit of the present invention is not limited thereto and may be changed and modified in various ways by those skilled in the art.

In a case where it is stated that any components are “connected” or “coupled” to other components, it is to be understood that the components may be directly connected or coupled to other components, but there is another component therebetween. On the other hand, in the case that it is stated that any components are “directly connected” or “directly coupled” to other components, it is to be understood that there is no another component therebetween.

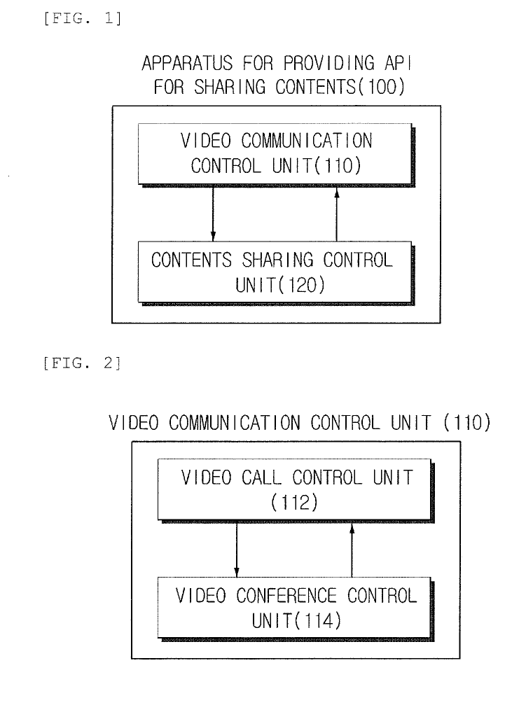

FIG. 1 is a block diagram of an apparatus for providing an API for sharing contents according to an exemplary embodiment of the present invention.

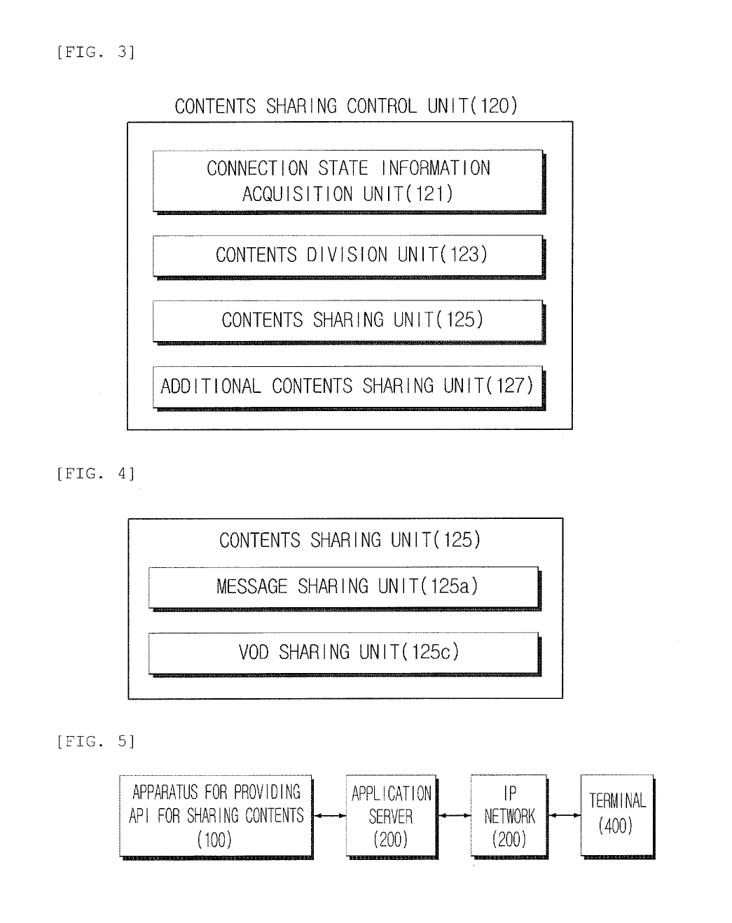

FIG. 2 is a block diagram for describing an exemplary embodiment of a video communication control unit in the apparatus for providing an API for sharing contents according to the exemplary embodiment of the present invention.

FIG. 5 is a block diagram for describing an exemplary embodiment of a system to which the apparatus for providing an API for sharing contents according to the exemplary embodiment of the present invention is applied.

Describing an apparatus 100 for providing an API for sharing contents with reference to FIGS. 1, 2, and 5, the apparatus 100 for providing an API for sharing contents includes a video communication control unit 110 and a contents sharing control unit 120.

The video communication control unit 110 may request a video call or video conference to terminals 400 and acquire connection state information of the terminals 400. The video communication control unit 110 may include a video call control unit 112 or a video conference control unit 114.

The video communication control unit 110 may request a video call or video conference to a plurality of terminals 400 for the video call or the video conference.

Only some of the plurality of terminals 400 receiving the video communication request may be connected to the video communication control unit 110 or all the terminals 400 may be connected to the video communication control unit 110. After the video call or the video conference starts, another terminal 400 may be additionally connected to the video call or the video conference. The video communication request to the each terminal 400 may be made by an application server 200 rather than by the video communication control unit 110 according to the system to which the method for providing an API for sharing contents is applied.

The video call control unit 112 requests the video call to the terminals 400, and acquires the connection state information of the terminals 400 when the terminals 400 and the apparatus 100 for providing an API for sharing contents are connected with each other by the video call. After the video call starts, another terminal 400 may be additionally connected with the video call control unit 112 for the video call. The video call control unit 112 may acquire the connection state information of the terminal additionally connected with the video call control unit 112.

The video conference control unit 114 requests the video conference to the terminals 400, and acquires the connection state information of the terminals 400 when the terminals 400 and the apparatus 100 for providing an API for sharing contents are connected with each other by the video conference. After the video conference starts, another terminal 400 may be additionally connected with the video conference control unit 112 for the video conference. The video conference control unit 112 may acquire the connection state information of the terminal additionally connected with the video call control unit 112.

In detail, in the process of acquiring the connection state information of the terminals 400, the video call control unit 112 acquires the connection state information of the terminals 400 based on a response to the video call or video conference request of the terminals 400.

In more detail, when the terminals 400 approve the video call or video conference request, the video call control unit 112 acquires the state information that the terminals 400 are connected with the video communication control unit 110. When the terminals 400 reject the video call or video conference request or do not respond to the request for a predetermined time or more, the video call control unit 112 acquires the state information that the terminals 400 are disconnected with the video communication control unit 110.

When the terminals 400 do not respond to the request for a predetermined time or more and respond to the request later, the video call control unit 112 acquires the state information that the terminals 400 are connected with the video communication control unit 110.

The terminals 400 are a device with a display such as computers, notebooks, tablets, mobile phones, and the like, that are used to participate in the video call or the video conference. The terminals 400 are connected with the apparatus 100 for providing an API for sharing contents through an IP network.

FIG. 3 is a block diagram for describing an exemplary embodiment of a contents sharing control unit in the apparatus for providing an API for sharing contents according to the exemplary embodiment of the present invention.

Describing a contents sharing control unit 120 with reference to FIG. 3, the contents sharing control unit 120 includes a connection state information acquisition unit 121, a contents division unit 123, a contents sharing unit 125, and an additional contents sharing unit 127.

The connection state information acquisition unit 121 acquires the connection state information of the terminals 400 from the video communication control unit 110.

In detail, when the connection state information acquisition unit 121 intends to acquire the connection state information of the terminals 400, the connection state information acquisition unit 121 acquires information using a notification mechanism using functions provided by the parlay-X, and the like, that are a standard of the open API in the open web service platform.

In more detail, the notification mechanism is a mechanism that requests the connection state information of the terminal 400 to the video communication control unit 110 as a start notification function when the contents division unit 123 receives the contents sharing request and delivers the connection state information of the terminal 400 to the connection state information acquisition unit 121 as a notify function when the video communication control unit 110 is requested to perform the start notification function. The start notification function and the notify function are functions provided by the parlay-X, and the like, that are the standard of the open API.

The connection state information acquisition unit 121 may acquire the connection state information of the additional terminals 400 from the video communication control unit 110 when there are additionally connected terminals 400 until the video communication such as a video call, a video conference, and the like, ends.

In detail, the connection state information of the additional terminals 400 may be notified to the video communication control unit 110 by allowing the video communication control unit 10 to use the notify function that is the function provided by the parlay-X, and the like, that are the standard of the open API.

The contents division unit 123 divides a kind of contents requested to the contents sharing control unit 120.

In detail, the contents division unit 123 may receive the contents sharing request from the application server 200. The terminals 400 that participate in the video communication such as a video call, a video conference, and the like, may perform the contents sharing request through the application server 200. The application server 200 receives the contents sharing request of the terminals 400 that participate in the video call or the video conference and delivers the received contents sharing request to the contents sharing control unit 120. The contents division unit 123 divides whether the sharing requested contents are contents of a video on demand (VOD) format or a web format. The contents of the VOD format may be a file of a format that may be shared as a VOD playback function among functions provided by the parlay-X, and the like, that are the standard of the open API such as moving pictures, songs, voice files, and the like. The contents of the web format may be a file of a format that may be shared as a message delivery function among functions provided by the parlay-X, and the like, that are the standard of the open API such as web page addresses, and the like. The VOD format or the web format may be divided by an extension of the file, and the like.

In a case where the information acquired in the connection state information acquisition unit 121 is the state information that the terminals 400 are connected, the contents sharing unit 125 shares the sharing-requested contents in the terminals 400 with the state information that the terminals are connected.

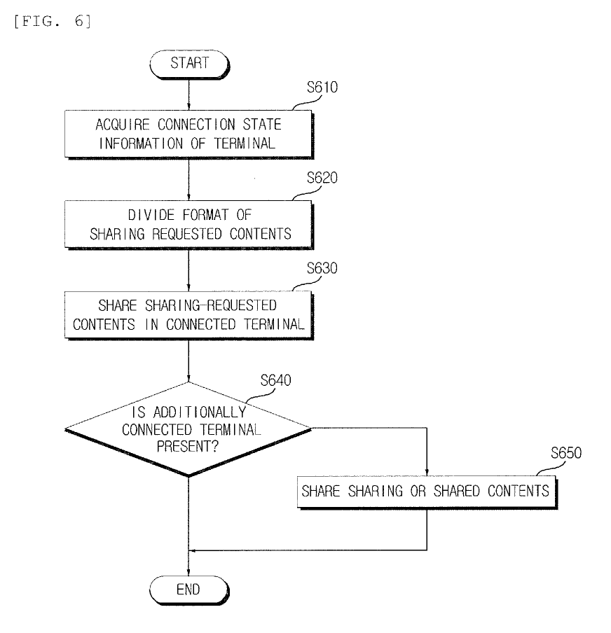

FIG. 4 is a block diagram for describing the contents sharing unit of the contents sharing control unit in the apparatus for providing an API for sharing contents according to the exemplary embodiment of the present invention.

Describing in detail the contents sharing unit 125 with reference to FIG. 4, the contents sharing unit 125 includes a message sharing unit 125a and a VOD sharing unit 125c.

The message sharing unit 125a shares the contents of the web format in the terminals 400 with the information that the terminals are connected, by using the message delivery function provided by the parlay-X, and the like, that are the standard of the open API in the platform including the open web service gateway.

The VOD sharing unit 125c shares the contents of the VOD format in the terminals 400 with the information that the terminals are connected, by using the VOD playback function provided by the parlay-X, and the like, that are the standard of the open API in the platform including the open web service gateway. The terminals 400 with the information that the terminals are connected are referred to as the connected terminals 400.

The additional contents sharing unit 127 shares at least one of the sharing or shared contents in the additionally connected terminals 400 when the connection presence of the additional terminals 400 is notified from the connection state information acquisition unit 121 after the sharing of the contents sharing-requested to the connected terminals 400 starts.

In detail, the additional contents sharing unit 127 may share at least of the sharing or shared contents using the contents sharing unit 125 during the process of sharing at least of the sharing or shared contents in the additionally connected terminals 400.

That is, when the contents to be shared in the additionally connected terminals 400 are the contents of the web format, the contents may be shared using the message sharing unit 125a, and when the contents of the VOD format are shared in the additionally connected terminals 400, the contents may be shared using the VOD sharing unit 125c.

FIG. 5 is an exemplified diagram for describing an exemplary embodiment of a system to which the apparatus for providing an API for sharing contents according to the exemplary embodiment of the present invention is applied.

Describing the exemplary embodiment of the system to which the apparatus 100 for providing an API for sharing contents is applied with reference to FIG. 5, the system to which the apparatus 100 for providing an API for sharing contents is applied includes the apparatus 100 for providing an API for sharing contents, the application server 200, an IP network 300, and the terminals 400.

The apparatus 100 for providing an API for sharing contents provides the API providing the contents sharing function to the application server 200. The application server 200 may provide applications for contents sharing function services to the terminals 400 using the API provided from the apparatus 100 for providing an API for sharing contents. The application server 200 may be connected with the IP network 300 to provide the terminals 400 with the applications for the contents sharing function services using the API. The terminals 400 may perform the contents request through the application server 200.

The apparatus 100 for providing an API for sharing contents according to the exemplary embodiment of the present invention is inserted into the platform including the open web service gateway as a single module to provide the contents sharing function to users.

The apparatus 100 for providing an API for sharing contents according to the exemplary embodiment of the present invention may solve the inconvenience in that service developers or users need to implement a plurality of API calls and logics in the application server 200, by providing the API that may perform the contents sharing function in the platform including the open web service gateway.

The apparatus 100 for providing an API for sharing contents according to the exemplary embodiment of the present invention may facilitate the sharing of contents in the additionally connected terminals 400 when the connection of the additional terminal 400 is present, thereby promoting the smooth communication and meeting among the users of the terminals 400.

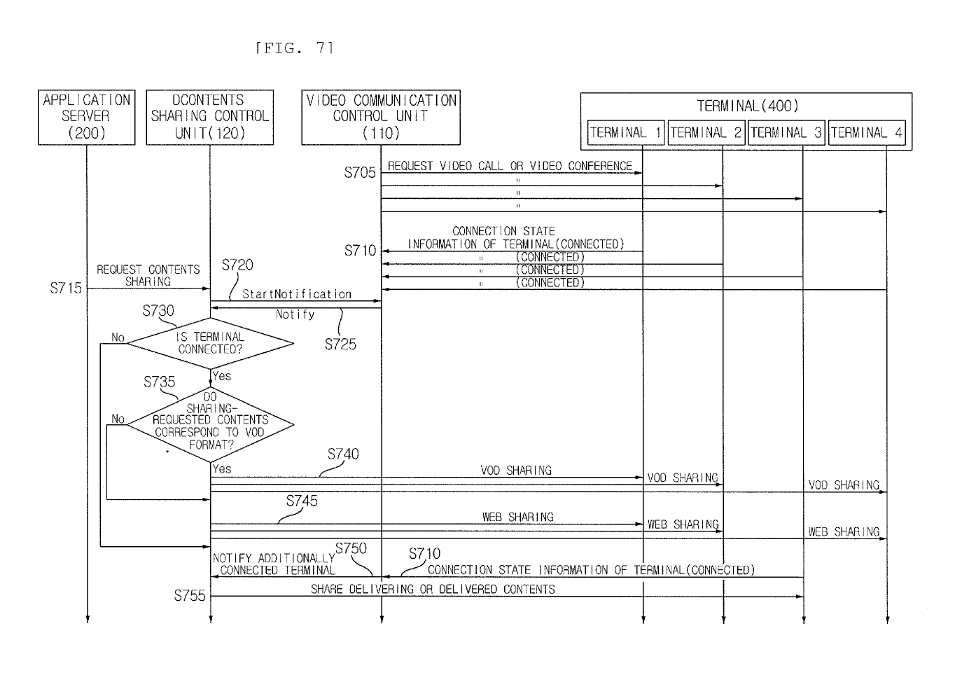

FIG. 6 is a flow chart of a method for providing an API for sharing contents according to the exemplary embodiment of the present invention.

Describing the method for providing an API for sharing contents according to the exemplary embodiment of the present invention with reference to FIG. 6, the connection state information acquisition unit 121 acquires the connection state information of the terminals 400 (S610). Acquiring the connection state information of the terminals 400 by the connection state information acquisition unit 121 may start when the sharing request is present. The connection state information acquisition unit 121 may acquire the connection state information of the terminals 400 from the video communication control unit 110 when the video communication such as a video call, a video conference, and the like, ends.

The contents division unit 123 divides whether the format of the sharing-requested contents is the web format or the VOD format (S620).

The contents sharing unit 125 shares the sharing-requested contents in the connected terminals 400 (S630).

In detail, the contents sharing unit 125 includes the message sharing unit 125a and the VOD sharing unit 125c. When the contents format divided by the contents division unit 123 is the web format, the message sharing unit 125a shares the contents in the connected terminals 400, and when the divided contents format is the VOD format, the VOD sharing unit 125c shares the contents in the connected terminals 400.

The additional contents sharing unit 127 shares the sharing or shared contents in the additionally connected terminals 400 when the additionally connected terminals 400 are present during the video communication (S640) (S650).

In detail, the additional contents sharing unit 127 may acquire the presence of the additionally connected terminal 400 through the connection state information acquisition unit 121 during the video communication. The additional contents sharing unit 127 may share the sharing or shared contents in the additionally connected terminal 400 by using the contents sharing unit 125.

FIG. 7 is a flow chart for describing a process to which a method for providing an API for sharing contents according to the exemplary embodiment of the present invention is applied.

Describing a flow chart for describing a process to which a method for providing an API for sharing contents according to the exemplary embodiment of the present invention is applied with reference to FIG. 7, the video communication control unit 110 may request the video communication such as a video call, a video conference, and the like, to each terminal 400 (S705). The application server 200 rather than the video communication control unit 110 may request the video communication to each terminal 400 according to the system to which the method for providing an API for sharing contents is applied.

If the terminals 400 approve, reject, or disregard the request of the video communication control unit 110, the video communication control unit 110 acquires the connection state information of the terminal 400 according to the response (S710).

In detail, the video communication control unit 110 acquires the connection state information that the terminals 400 are connected, when the terminals 400 approves the request, and acquires the connection state information that the terminals 400 are disconnected, when the terminals 400 rejects or disregards the request. If the terminals 400 disregard the request or do not respond to the request for a predetermined time and respond to the request later, the video communication control unit 110 acquires the connection state information that the terminals 400 are connected when the terminals 400 approve the request.

If the terminals 400 request the contents sharing with other connected terminals 400 through the application server 200 (S715), the contents sharing control unit 120 receives the contents sharing request to request the information so as to confirm the connection state of the terminals 400 from the video communication control unit 110 (S720).

In detail, the contents sharing control unit 120 uses a start notification function provided by the parlay-X, and the like, that are the standard of the open API to request the connection state information of the terminals 400 to the video communication control unit 110. This may be performed by the connection state information acquisition unit 121 in the contents sharing control unit 120.

The video communication control unit 110 receives the request of the connection state information of the terminals 400 from the contents sharing control unit 120 and delivers the connection state information of the terminals 400 to the contents sharing control unit 120 (S725).

In detail, the video communication control unit 110 delivers the connection state information of the terminals 400 to the contents sharing control unit 120 by using the notify function provided by the parlay-X, and the like, that are the standard of the open API.

The contents sharing control unit 120 confirms the connection state of the terminals 400 from the video communication control unit 110 (S730), and when the terminals 400 are connected, divides whether the format of the sharing-requested contents is the web format or the VOD format (S735). The division of the sharing-requested format may be performed by the contents division unit 123.

When the format of the sharing-requested contents is the VOD format, the VOD sharing unit 125c of the contents sharing control unit 120 shares the VOD contents in the connected terminals 400 (S740).

When the format of the sharing-requested contents is the web format, the message sharing unit 125a of the contents sharing control unit 120 shares the contents of the web format in the connected terminals 400 (S745).

When the presence of the terminals 400 additionally connected to the video communication such as a video call, a video conference, and the like, is notified from the video communication control unit 110 (S750), the additional contents sharing unit 127 of the contents sharing control unit 120 shares the sharing or shared contents (S755).

In detail, the presence of the additionally connected terminal 400 from the video communication control unit 110 may be notified by using the notify function provided by the parlay-X, and the like, that are the standard of the open API. The additional contents sharing unit 127 may share contents by using the message sharing unit 125a or the VOD sharing unit 125c.

The apparatus 100 for providing an API for sharing contents according to the exemplary embodiment of the present invention may solve the inconvenience in that service developers or users need to implement a plurality of API calls and logics in the application server 200, by providing the API that may perform the contents sharing function in the platform including the open web service gateway.

As described above, the exemplary embodiments have been described and illustrated in the drawings and the specification. The exemplary embodiments were chosen and described in order to explain certain principles of the invention and their practical application, to thereby enable others skilled in the art to make and utilize various exemplary embodiments of the present invention, as well as various alternatives and modifications thereof. As is evident from the foregoing description, certain aspects of the present invention are not limited by the particular details of the examples illustrated herein, and it is therefore contemplated that other modifications and applications, or equivalents thereof, will occur to those skilled in the art. Many changes, modifications, variations and other uses and applications of the present construction will, however, become apparent to those skilled in the art after considering the specification and the accompanying drawings. All such changes, modifications, variations and other uses and applications which do not depart from the spirit and scope of the invention are deemed to be covered by the invention which is limited only by the claims which follow.

What is claimed is:

1. An apparatus for providing an API for sharing contents during video communication in a platform including an open web service gateway, the apparatus comprising:
a video communication control unit configured to acquire connection state information of terminals receiving a video communication request; and
a contents sharing control unit configured to receive the connection state information of the terminals from the video communication control unit and process a contents sharing request.

2. The apparatus of claim 1, wherein the video communication control unit acquires the connection state information of the terminals based on whether the terminals receiving the video communication request responds to the video communication request.

3. The apparatus of claim 2, wherein the connection state information of the terminals according to the response of the terminals is acquired as the state information that the terminals are disconnected, when the terminals reject the video communication request, and as the state information that the terminals are connected, when the terminals approve the video communication request.

4. The apparatus of claim 1, wherein the contents sharing control unit includes:
a connection state information acquisition unit configured to acquire the connection state information of the terminals from the video communication control unit; and
when information acquired from the connection state information acquisition unit is the state information that the terminals are connected, a contents sharing unit configured to share the sharing-requested contents in the terminals with the state information that the terminals are connected.

5. The apparatus of claim 4, wherein the connection state information acquisition unit acquires the connection state information of the terminals by using a notification mechanism provided from the open web service gateway.

6. The apparatus of claim 5, wherein the notification mechanism is a mechanism that requests the connection state information of the terminals to the video communication control unit as a start notification function provided from the open web service gateway when the connection state information acquisition unit receives the contents sharing request, and delivers the connection state information of the terminals to the connection state information acquisition unit as a notify function provided from the open web service gateway, when the video communication control unit receives the request of the connection state information as the start notification function.

7. The apparatus of claim 4, wherein the contents sharing unit includes:
when a format of the sharing-requested contents is a web format, a message sharing unit configured to share the contents of the sharing-requested web format in the terminals with the state information that the terminals are connected; and
when the format of the sharing-requested contents is a video on demand (VOD) format, a VOD sharing unit configured to share the contents of the sharing-requested VOD format in the terminals with the state information that the terminals are connected.

8. The apparatus of claim 7, wherein the message sharing unit shares the contents of the web format in the terminals with the state information that the terminals are connected, by using a message delivery function provided from the open web service gateway.

9. The apparatus of claim 7, wherein the VOD sharing unit shares the contents of the VOD format in the terminals with the state information that the terminals are connected, by using a VOD playback function provided from the open web service gateway.

10. The apparatus of claim 4, further comprising:
a contents division unit configured to divide whether the sharing-requested contents are the contents of the web format or the contents of the VOD format.

11. The apparatus of claim 4, wherein the contents sharing control unit further includes an additional contents sharing unit configured to receive the notification of the connection presence of additional terminals from the connection state information acquisition unit when the additional terminals are connected with the video communication after the sharing of the sharing-requested contents in the connected terminals starts, and share at least one of the sharing or shared contents in the additionally connected terminals.

12. A method for providing an API for sharing contents during video communication in a platform including an open web service gateway, the method comprising:
a video communication controlling step of acquiring connection state information of terminals receiving a video communication request; and
a contents sharing controlling step of receiving the connection state information of the terminals from a video communication control unit and processing a contents sharing request.

13. The method of claim 12, wherein the contents sharing controlling step includes:
a connection state information acquiring step of acquiring the connection state of the terminals from the video communication control unit; and
when information acquired in the connection state information acquiring step is the state information that the terminals are connected, a contents sharing step of sharing the sharing-requested contents in the terminals with the state information that the terminals are connected.

14. The method of claim 13, wherein in the connection state information acquiring step, the connection state information of the terminals is acquired by using a notification mechanism provided from the open web service gateway.

15. The method of claim 14, wherein the notification mechanism the notification mechanism is a mechanism that requests the connection state information of the terminals in the video communication controlling step as a start notification function provided from the open web service gateway in the connection state information acquiring step and delivers the connection state information of the terminals in the connection state information acquiring step as a notify function provided from the open web service gateway in the video communication controlling step.

16. The method of claim 13, wherein the contents sharing step includes:
when a format of the sharing-requested contents is a web format, a message sharing step of sharing the contents of the sharing-requested web format in the connected terminals; and
when the format of the sharing-requested contents is a video on demand (VOD) format, a VOD sharing step of sharing the contents of the sharing-requested VOD format in the terminals with the state information that the terminals are connected.

17. The method of claim 16, wherein the message sharing step shares the contents of the web format in the terminals with the state information that the terminals are connected, by using a message delivery function provided from the open web service gateway.

18. The method of claim 16, wherein the VOD sharing step shares the contents of the VOD format in the connected terminals by using a VOD playback function provided from the open web service gateway.

19. The method of claim 13, further comprising:
a contents division step of dividing whether the sharing-requested contents are the contents of the web format or the contents of the VOD format.

20. The method of claim 13, wherein the contents sharing control step further includes an additional contents sharing step of receiving the sharing request to share at least any one of the sharing or shared contents in the additionally connected terminals, when receiving the notification of the connection presence of additional terminals from the connection state determining step after the sharing of the sharing-requested contents in the connected terminals starts.
